(19) United States
(12) Patent Application Publication
(10) Pub. No.: US 2020/0202291 A1
(43) Pub. Date: Jun. 25, 2020

(54) BIOMETRIC AUTHENTICATION IN PRODUCT DISTRIBUTION

(71) Applicant: Konica Minolta Laboratory U.S.A., Inc., San Mateo, CA (US)

(72) Inventors: Kazuto Yamamoto, Foster City, CA (US); Randy Cruz Soriano, San Leandro, CA (US)

(21) Appl. No.: 16/228,619

(22) Filed: Dec. 20, 2018

(51) Int. Cl. G06Q 10/08; H04L 29/06; H04L 9/06

(52) U.S. Cl. CPC G06Q 10/0833; H04L 2209/38; H04L 9/0637; H04L 63/0861

(57) ABSTRACT

There is often little or no assurance as to the identity of certain persons involved in a product supply chain. A need arises to validate the identity of a person to prevent theft or to prevent introduction of counterfeit or adulterated goods. This may be achieved with a biometric validation process, as a condition to generating a record of a product transfer event. Such events include the receipt or sending of a product. As part of the product transfer event, a product ID for the product as well as a handler ID are obtained. The handler ID identifies a societal entity (e.g., a person or company) or machine (e.g., an RFID scanner) involved in the product transfer event. The handler ID and the biometric ID corroborate each other, thereby increasing accountability and integrity of the product transfer record. The product transfer record may then be forwarded to a blockchain process.

### FIELD

This disclosure relates generally to electronic tracking of goods and, more particularly, to biometric authentication in product distribution.

### BACKGROUND

Product distribution is often subjected to electronic tracking. For example, a product ordered via the Internet by a customer of an online retailer may be tracked across various points in the product supply chain, from a point of shipment, to a courier facility, to a delivery truck, and finally to a delivery address. Conventionally, there is little or no assurance as to the identity of a person involved in the delivery chain. The signature of the addressee on a package may be forged. Even when a computer, product scanner or other device is used to confirm delivery or receipt of a product, the person using the device may not be who is intended to handle the product. Though devices may require security passwords, such passwords may be stolen and then misused in a way that that results in a false record that a product was sent and/or received.

In certain situations, a need may arise to validate the identity of persons involved in a product supply chain. The need may arise to prevent theft, to prevent introduction of counterfeit goods in the supply chain, and/or to establish accountability and integrity of handling records. The need may stem from government regulations. In the United States for example, the Drug Supply Chain Security Act (DSCA) imposes requirements intended to insure the legitimacy and traceability of certain pharmaceutical products. The requirements apply to manufacturers, repackagers, wholesale distributors, dispensers, and third-party logistics providers. An important provision of the DSCA is to provide a step-by-step account of where a pharmaceutical product has been located and who has handled it.

Accordingly, there is need for a method and system for applying a form of identity verification in product distribution.

### SUMMARY

Briefly and in general terms, the present invention is directed to a method, system, and non-transitory computer-readable medium for applying biometric authentication in product distribution.

In aspects, a method comprises performing a biometric validation process, the biometric validation process performed for a first product transfer event involving a product. The biometric validation process comprises receiving handling information comprising a product ID for the product and a handler ID, the handler ID linking the product with a societal entity or machine involved in handling the product; receiving a biometric ID of a user associated with the handling information; and determining whether the received biometric ID is valid, including determining whether the received biometric ID corresponds to the received handler ID. The method comprises, responsive to a determination that the received biometric ID is valid, forwarding a first handling record to a blockchain process, the first handling record comprising the received handling information, the blockchain process for establishing a first data block containing a first hash linked to the first handling record.

In aspects, a system, which is for applying biometric authentication in product distribution, comprise a computer processor configured to perform a method, which comprises performing a biometric validation process, the biometric validation process performed for a first product transfer event involving a product. The biometric validation process comprises receiving handling information comprising a product ID for the product and a handler ID, the handler ID linking the product with a societal entity or machine involved in handling the product; receiving a biometric ID of a user associated with the handling information; and determining whether the received biometric ID is valid, including determining whether the received biometric ID corresponds to the received handler ID. The method, which the computer processor is configured to perform, further comprises, responsive to a determination that the received biometric ID is valid, forwarding a first handling record to a blockchain process, the first handling record comprising the received handling information, the blockchain process for establishing a first data block containing a first hash linked to the first handling record.

In aspects, a non-transitory computer-readable medium stores instructions, which when executed by a computer processor, cause the computer processor to perform a method for applying biometric authentication in product distribution. The method comprises performing a biometric validation process, the biometric validation process performed for a first product transfer event involving a product. The biometric validation process comprising receiving handling information comprising a product ID for the product and a handler ID, the handler ID linking the product with a societal entity or machine involved in handling the product; receiving a biometric ID of a user associated with the handling information; and determining whether the received biometric ID is valid, including determining whether the received biometric ID corresponds to the received handler ID. The method comprises, responsive to a determination that the received biometric ID is valid, forwarding a first handling record to a blockchain process, the first handling record comprising the received handling information, the blockchain process for establishing a first data block containing a first hash linked to the first handling record.

The features and advantages of the invention will be more readily understood from the following detailed description which should be read in conjunction with the accompanying drawings.

### BRIEF DESCRIPTION OF THE DRAWINGS

FIG. 1 is a schematic diagram showing an example system for applying biometric authentication in product distribution and a blockchain process applied to product handling records.

FIG. 2 is a schematic diagram showing a peer-to-peer network of the system.

FIG. 3 is a flow diagram showing a biometric validation process

FIG. 4 is a diagram showing a product handling record generated by merging handling information and a biometric ID received during the biometric validation process.

FIG. 5 is a schematic diagram showing a modification of the system.

### DETAILED DESCRIPTION

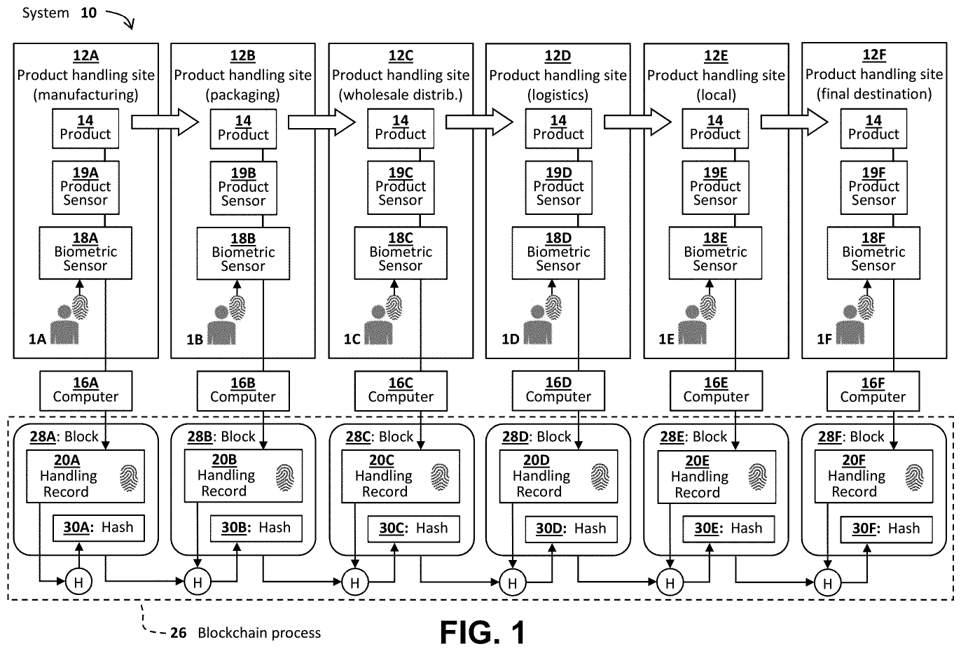

Referring now in more detail to the drawings for purposes of illustrating non-limiting examples, wherein like reference numerals designate corresponding or like elements among the several views, there is shown in FIG. 1 example system 10 operating in a supply chain involving a series of product handling sites 12A-12F. As used herein a letters is combined with a number for a group of elements, where the letter identifies a specific member of the group. For example, reference sign 12 refers one or more product handling sites generally (as indicated by context), and reference sign 12A refers to a particular product handling site.

In the illustrated example, product handling sites 12 correspond to a manufacturing site, packaging site, wholesale distribution site, logistics site, regional site, local site, and final destination site. Here, the manufacturing site begins the supply chain and is where product 14 originates. Product 14 is a good or other physical item. Examples of a product include a pharmaceutical product, a medical device, food, jewelry, clothing, and work of art, just to name a few. The packaging site is where product 14 is packaged individually or together with additional products. The wholesale distribution site is warehouse that receives packaged products. The logistics site may be a staging facility, such as postal or courier warehouse, that receives products in preparation for air, sea, or land transport. Alternatively, the logistics site may be a delivery vehicle. The local site may be a temporary holding facility, or it may be a hospital, a pharmacy, corporate mail room, drug store, or other type of retail store. The final destination site ends of the supply chain. The final destination site may be a retail store, a person's hospital room, office, or house, or a public delivery locker (drop locker). For simplicity, this example shows only one logistics site, though in other examples, there may be several logistics sites inserted between the manufacturing, wholesale distribution, packaging, local, and final destination sites. Furthermore, in other examples, there may be multiple product handling sites within each of the mentioned sites. For example, a wholesale distribution site may have a product handling site where a product enters a warehouse, and another product handling site where the product subsequently leaves the warehouse. It is to be understood that the illustrated product handling sites are examples, and the invention applies to other supply chains with other types of product handling sites.

As shown in FIG. 1, system 10 comprises computers 16 and biometric sensor 18. Biometric sensor 18 is configured to obtain a biological trait from user 1. Computer 16 is configured to obtain various inputs from user 1. The inputs provide system 10 with product handling information, as will be discussed below. Optionally, system 10 comprises product sensor 19, which user 1 may use to provide at least some of the product handling information.

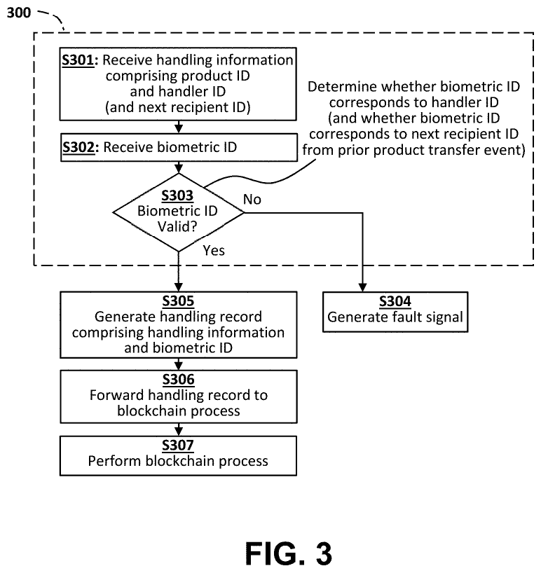

A product transfer event occurs at each product handling site 12. At each product handling site 12, there is user 1 who is involved in a product transfer event. A product transfer event may be an event in which product 14 is received and immediately sent out by user 1. A product transfer event may be an event in which product 14 is received by user 1 who holds it for a time. For example, an employee (e.g., having a personal ID of “John 001”) working in an inspection department (e.g., having a group ID of “Group A”) may receive product 14 and place it in a queue for inspection. A product transfer event may be an event in which product 14 is sent out by user 1. Continuing from the above example, John 001 or another employee in Group A (e.g., having a personal ID of “Mark 002”) completes the inspection on product 14 and sends it to a person (e.g., having a personal ID of “Jill 009”) who is intended to be the next recipient. Computer 16 is configured to generate handling record 20 of details about the product transfer event. Handling record 20 is generated only if a biometric ID of the respective user (e.g., John 001, Mark 002, or Jill 009) is validated by a biometric validation process (FIG. 3).

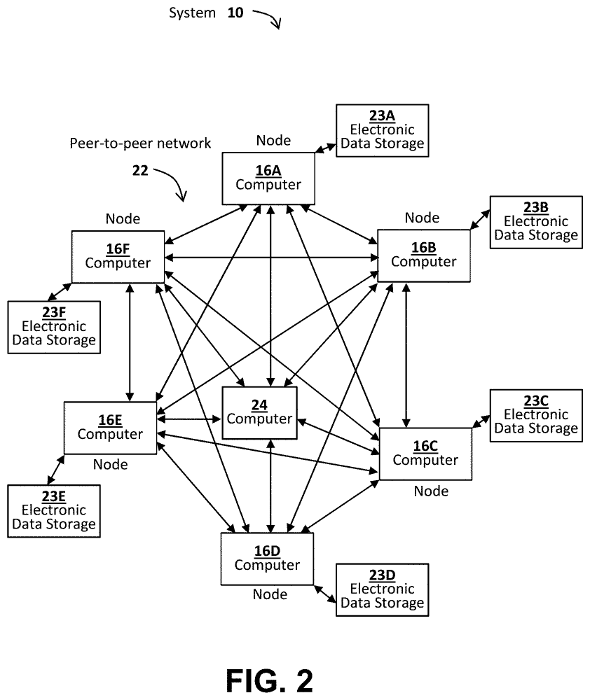

As shown in FIG. 2, computers 16 may be interconnected as nodes in a peer-to-peer network 22. Each computer 16 is a node in network 22. Each computer 16, per the example of FIG. 1, is associated with (e.g., receives information from) only a single product handling site. Network 22 may include other nodes, such as computer 24, which is associated with (e.g., receives information from) a plurality of product handling sites. System 10 comprises network 22 and electronic data storage 23. Each computer 16 in network 22 includes one or more computer processors which may or may not be housed together. As used herein, the term “computer processor” refers to one or more computer processors. The computer processor comprises electronic circuits that allow the computer processor to perform the method described herein. Computer 16 may include memory, including a non-transitory computer-readable medium, storing instructions for performing the method described herein. For example, computer 16 may comprise server class hardware running a server operating system. Electronic data storage 23 includes mass storage devices, such as solid state drives, hard drives, and optical storage.

Each computer 16 generates handling record 20 containing details about the product transfer event that occurs at the respective product handling site 12. Computer 16 may forward handling record 20 to blockchain process 26 (FIG. 1), which establishes data block 28 containing hash 30 linked to handling record 20. Details of the blockchain process 26 will be described later. Blockchain process 26 may be performed by computer 16 associated with product handling site 12 where the product transfer event took place. Alternatively, blockchain process 26 may be performed by another one of the nodes in network 22. For example, blockchain process 26 may be performed by computer 24, which receives different handling records 20 at various times from computers 16.

FIG. 3 shows example biometric validation process 300 that may be performed for a product transfer event in any of product handling sites 12. Biometric validation process 300 may be performed repeatedly in sequence, starting at site 12A, next at site 12B, next at site 12C, and so on.

At S301, computer 16 receives handling information, which comprises a product ID for product 14 and a handler ID.

The product ID uniquely identifies product 14. The product ID may include any one or a combination of an RFID tag identifier, a unique serial number, a product name, a manufacturing lot number, a national drug code number, and a Universal Product Code (UPC).

The product ID may be entered manually by user 1 to computer 16. Additionally or alternatively, the product ID may be received by computer 16 from electronic data storage 23 associated with computer 16 (e.g., a mass storage device connected to computer 16, or from a server computer in communication with computer 16) based on a product selection or other shortcut entered into computer 16 by user 1. Additionally or alternatively, the product ID may be received by computer 16 via product sensor 19. Product sensor 19 is in communication with computer 16 and is operated by user 1. For example, product sensor 19 can be a contactless identification device configured to read information about the product using electromagnetic radiation directed toward the product. Product sensor 19 may use electromagnetic radiation to retrieve or read data from a radio frequency tag, code label, or electronic device physically associated with product 14. Examples of a contactless identification device include an RFID reader, an optical barcode reader, and NFC (Near Field Communication) scanner, as are known in the art. An RFID reader scans an RFID tag that is attached or will be attached to product 14. An optical barcode reader scans a barcode that is printed on, or is attached or will be attached to product 14. An NFC scanner scans an NFC tag that is attached or will be attached to product 14.

The product ID, or portions thereof, may base based on or comprise outputs from product sensor 19. For example, an RFID tag or an NFC tag may transmit the product ID, or portions thereof, to computer 16. Computer 16 may use output from product sensor 19 (e.g., a serial number or other code) as a reference to obtain the product ID, or portions thereof, from electronic data storage 23 associated with computer 16 (e.g., a mass storage device connected to computer 16, or from a server computer in communication with computer 16).

The handler ID links product 14 with a societal entity or machine involved in handling the product. A societal entity is associated with one or more persons who are identifiable, so a person or persons may be held accountable for the product transfer event. The societal entity may be a person or persons asserting control over the product during the product transfer event. For example, a societal entity may be an individual person (e.g., a person having a personal ID of John 001, Mark 002, or Jill 009 in the above example). A societal entity may be a group of people (e.g., a department having a group ID of “Group A” in which John 001 and Mark 002 belong). A societal entity may be company that is operated by or associated with an individual person or a group of people (e.g., a retail store having a group ID of “Group B” operated by Jill 009).

Next at S302, computer 16 receives a biometric ID of a user associated with the handling information. A biometric ID input of a user distinguishes the user based on a biological trait of the user. Examples of a biometric ID input include data representing a fingerprint, eye scan, voice pattern, facial pattern, and heartbeat (electrocardiogram) of the user. The biometric ID is based on or comprises output from biometric sensor 18. Examples for biometric sensor 18 include without limitation a device comprising a touchpad configured to be touched by a finger of the user and read a fingerprint from the finger. Biometric sensor 18 may be a device comprising a microphone configured to detect speech from the user and ascertain a voice pattern. Biometric sensor 18 may be a device comprising a digital camera. The camera may be configured to optically scan an eye of the user and ascertain an eye pattern from the eye, or configured to take a picture of the face of the user and ascertain a facial pattern from the picture. Biometric sensor 18 may be an electrical sensor configured to detect a heartbeat or electrocardiogram (ECG) of the user.

The biometric ID received at S302 is that of a user associated with the handling information received at S301. As such, the handling information may be traced back to a particular person, namely the user who provided the biometric ID. That person may be contacted if the accuracy of the handling information needs to be verified days, months, or years later. In addition, the biometric ID provides corroboration as to the legitimacy of the handler ID, as discussed below (see S303). The biometric ID is linked to the handling information. For example, the user may enter the handling information into computer 16 via one or a combination of manual entry (e.g., using a keyboard or touch sensitive screen connected to computer 16), voice command (e.g., via a microphone connected to computer 16), and machine-assisted entry (e.g., using product sensor 19 connected to computer 16). At the time of entering the handling information, computer 16 may require the user to provide a biometric ID via biometric sensor 18 connected to computer 16. Computer 16 may automatically obtain a biometric ID via biometric sensor 18 connected to computer 16 at the time of entry. The user may provide the biometric ID via biometric sensor 18 during a login process performed for computer 16. Thus, computer 16 associates the received handling information and the received biometric ID. Computer 16 may store in memory the received handling information in association with the received biometric ID.

Next at S303 (FIG. 3), computer 16 determines whether the received biometric ID is valid. This determination includes determining whether the received biometric ID corresponds to the received handler ID. This provides corroboration as to the legitimacy of the handler ID. For example, if the received handler ID comprises a personal ID of an individual person, the biometric ID should correspond to that person. Thus, the biometric ID provides assurance that somebody is not impersonating that person. If the received handler ID comprises a group ID for a group of people, then the biometric ID should correspond to a person in the group. Thus, the biometric ID provides assurance that somebody is truly associated with the group. If the received handler ID identifies a machine having a physical association with the product, then the biometric ID should correspond to the machine. For example, product sensor 19 is a machine having a physical association with product 14 since product sensor 19 and product 14 are present together at the product transfer event. Thus, the biometric ID provides assurance that the machine is being used by an authorized person and is not being used by a thief or imposter. By checking whether the user is authorized to use the machine, an imposter may not use the machine to create a false record of a product transfer event.

To determine whether the received biometric ID corresponds to the received handler ID, computer 16 may reference a lookup table or other database. TABLE I shows an example lookup table.

TABLE I

| | | Biometric Data | |
|---|---|---|---|
| Group ID | Personal ID | reference file | Device ID |
| Group A | John 001 | File A1 | RFID reader 5A |
| | Mark 002 | File A2 | NFC scanner 3A |
| Group B | Jill 009 | File B1 | RFID reader 2B |
| Group C | James 007 | File C1 | None |
| | Frank 003 | File C2 | None |
| | Mary 010 | File C3 | Barcode scanner 3A |
| | Susan 005 | File C4 | Barcode scanner 3A |

The various IDs in TABLE I are non-limiting examples. The personal ID may include an employee name, employee number, a unique code, computer username, or other identifier that distinguishes a person from other persons. The group ID may include a company name, code, and/or other identifier that distinguishes one group from others. The device ID may include a device name, serial number, code, and/or identifier that distinguishes one device from others.

If at S301 (FIG. 3) the handler ID comprises a personal ID that is “John 001,” computer 16A at S303 may compare the received biometric ID against John's biometric data in reference File A1 to try to find a match. Alternatively or additionally, if the handler ID comprises a group ID that is “Group A,” computer 16A at S303 may compare the received biometric ID against the biometric data in reference Files A1 and A2 to try to find a match. Alternatively or additionally, if the handler ID comprises a device ID that is “RFID Reader 5A,” computer 16 at S303 determines that “RFID Reader 5A” is associated with reference File A1, and then computer 16 compares the received biometric ID against the biometric data in reference File A1 to try to find a match. If the handler ID comprises a device ID that is “Barcode scanner 3A,” computer 16 at S303 determines that “Barcode scanner 3A” is associated with reference Files C3 and C4, and then computer 16 compares the received biometric ID against the biometric data in reference Files C3 and C4 to try to find a match.

If there is no match at S303, computer 16 generates at S304 a fault signal indicating the received biometric ID does not correspond to the received handler ID. Computer 16 may reject the received handler ID or computer 16 may reject the received handling information entirely. Perhaps the user made a typographical error, so the user may enter another handler ID. Perhaps the user inadvertently used the wrong machine (e.g., product sensor 19) during the product transfer event, so the user may try to find the correct machine. If the user is not authorized to use any of the machines, then another person must handle the product transfer event.

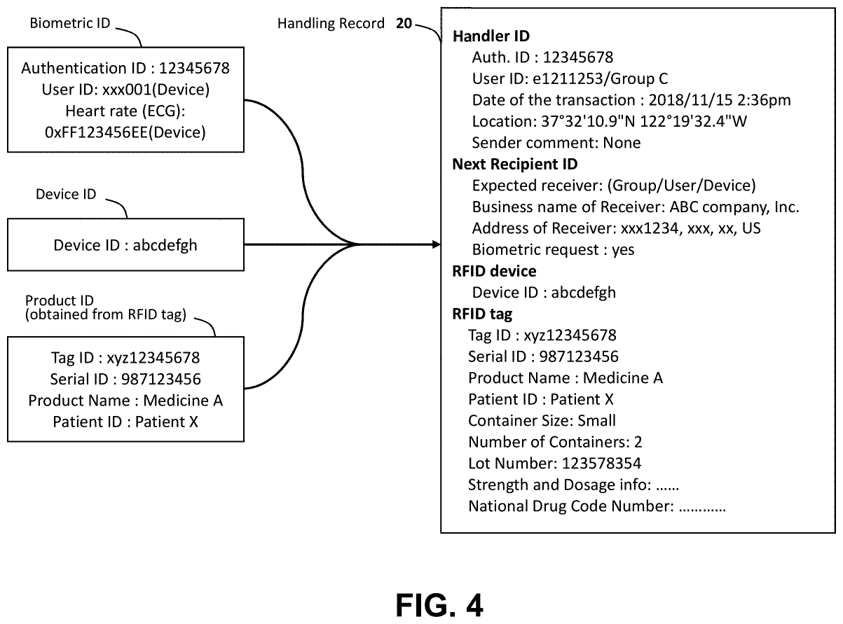

If there is a match at S303, computer 16 accepts the received handling information and uses it to generate at S305 handling record 20. Handling record 20 includes the received handling information and the received biometric ID. As shown in FIG. 4, computer 16 may merge the received handling information and the received biometric ID to generate handling record 20.

Next at S306, computer 16 forwards handling record 20 to blockchain process 26 (FIG. 1). Computer 16 may perform blockchain process 26, or another node in network 22 may perform it. The blockchain process establishes data block 28 containing hash 30 which is linked to handling record 20. Handling record 20 is subjected to a hash function to generate hash 30. The hash function (“H” in FIG. 1) may utilize SHA (Secure Hash Algorithm) or other cryptographic hash algorithm, as are known in the art. For example, the SHA-256 algorithm may be utilized. Hash 30 comprises a character string (hash string) of a predetermine length (number of characters). For example, hash string may be a string of 64 characters. If handling record 20 is revised or if another handling record is provided, the hash function will return a different hash string. Thus, every handling record 20 will be represented by a different hash string. The hash string (contained in hash 30) is unique to handling record 20. In this way, hash 30 is linked to handling record 20.

Blockchain process 26 may insert a time stamp and block ID to data block 28. This may enable another computer, when handling a subsequent product transfer event, to easily find a previous block. A future block (e.g., block 28B) may be able to point to a previous block (e.g., block 28A) to allow a computer (e.g., computer 16B) to verify the product transfer event that it is currently handling. In addition, blockchain process 26 may insert a nonce to data block 28. A nonce may serve as “proof of work,” as known in the art. For example, a nonce is a character string which is added to block 28A to produce version #2 of block 28. A predetermined requirement for the nonce is that when version #2 is hashed, the resulting hash string will have a particular format. An example of a predetermined requirement is that the resulting hash string for version #2 must have a predetermined number (e.g., 5, 10, or 15) of leading zeros. The nonce is broadcasted to other nodes in network 22 to confirm that the nonce satisfies the predetermined requirement and to verify the transaction history of the handling record. When confirmed, other nodes accept the validity of block 28A. The same approach may be performed for inserting a nonce in blocks 28B, 28C, and so on.

With reference to FIG. 1 for example, a product transfer event at site 12A results in data block 28A from blockchain process 26. Block 28A comprises handling record 20A and hash 30A. If later, another computer obtains handling record X that purports to be handling record 28A, that computer may perform the same hash function on handling record X, and then compare the resulting character string against that of hash 30A. If the character strings do not match, then handling record X and handling record 28A are not the same. Thus, it will be appreciated that the hash provides assurance against tampering with handling records.

Biometric validation process 300 may be performed for a second product transfer event involving product 14. For example, product handling site 12A (FIG. 1) may send product 14 to product handling site 12B. Computer 16B performs biometric validation process 300 for the second product transfer event. The received biometric ID is that of user 1B. For convenience, it may be referred to as a second biometric ID. In addition, the handler ID received in the biometric validation process for the second product transfer event may be referred to as a second handler ID. If computer 16B determines at S303 that the second biometric ID is not valid, computer 16B generates a fault signal at S304. The fault signal would indicate that the second biometric ID does not correspond to the second handler ID. If computer 16B determines the second biometric ID is valid, computer 16 generates at S305 handling record 20B (second handling record). Second handling record 20B comprises the handling information and the biometric ID received in the biometric validation process for the second product transfer event.

For the second product transfer event, it may be desirable for computer 16B to determine whether site 12B (or more specifically, user 1B) should receive product 14 from site 12A. This may be accomplished follows. In the biometric validation process for the first product transfer event, the received handling information comprises a next recipient ID identifying a societal entity that should receive the product in the second product transfer event and/or identifying a machine physically associated with the product in the second product transfer. The next recipient ID would be included in handling record 20A. The next recipient ID may comprise any one or more of a personal ID, a group ID, and device ID. Descriptions of these types of IDs are provided above. In the biometric validation process for the second product transfer event, the process at S303 (for determining whether the received biometric ID is valid) comprises determining whether the second received biometric ID corresponds to the next recipient ID that was received in the biometric validation process for the first product transfer event (e.g., the next recipient ID in handling record 20A).

To determine whether the second biometric ID corresponds to the next recipient ID, computer 16B may reference a lookup table or other database. TABLE I (discussed above) shows an example lookup table. Referring to TABLE I, if the next recipient ID in handling record 20A comprises a personal ID that is “Jill 009,” computer 16B at S303 (FIG. 3) may compare the second biometric ID against Jill's biometric data in reference File B1 to try to find a match. Alternatively or additionally, if the next recipient ID in handling record 20A comprises a group ID that is “Group B,” computer 16 B determines that “Group B” is associated with reference File B1, and then computer 16 compares the second biometric ID against the biometric data in reference File B1. Alternatively or additionally, if the next recipient ID comprises a device ID that is “RFID Reader 2B,” computer 16B at S303 determines that “RFID Reader 2B” is associated with reference File B1, and then computer 16 compares the second biometric ID against the biometric data in reference File B1 to try to find a match.

If there is no match at S303 for the second product transfer event, computer 16B generates at S304 a fault signal indicating the second biometric ID (that of user 1B) does not correspond to the received next recipient ID. This mismatch may occur when, for example, the next recipient ID contains “RFID Reader 2B” and the second biometric ID (that of user 1B) does not correspond to the biometric data in reference File B1. This mismatch means that user 1B should not receive product 14 from site 12A even though user 1B is a person belonging to site 12B. With no match at S303, computer 16 may reject the handling information received in association with user 1B.

If there is a match at S303 for the second product transfer event, computer 16B accepts the received handling information and uses it to generate at S305 handling record 20B. Handling record 20B includes the handling information and the biometric ID received in the biometric validation process for the second product transfer event. Computer 16 may merge the received handling information and the received biometric ID to generate handling record 20B.

Next at S306 for the second product transfer event, computer 16B forwards handling record 20B to blockchain process 26. Computer 16B may perform blockchain process 26 at S307, or another node in network 22 may perform it. The blockchain process establishes data block 28B containing hash 30B linked to handling record 20B. In blockchain process 26, handling record 20B is subjected to a hash function to generate hash 30B, as previously described. In the example of FIG. 1, block 28A containing the handling record and hash from the first (previous) product transfer event is merged with handling record 20B for the second (current) product transfer event, and then the merged data is subjected to subjected to hash function H, which returns hash 30B to be included in block 28B. As previously discussed, different inputs to hash function H will return a different character string. In this case, the input includes handling record 28B, so the resulting character string (hash 30B) is unique to handling record 20B. In this way, hash 30B is linked to handling record 20B.

The blockchain process may be performed in other ways such that hash 30B is linked to handling record 20B. For instance, data block 28A may be hashed to produce a first hash string, handling record 20B may be hashed to produce a second hash string, and then both hash strings are included in hash 30B. Alternatively, the first and second hash strings may be merged and hashed, resulting a single hash string which is included in hash 30B. Alternatively, handling record 20A, hash 30A, and handling record 20B may be merged, and the merged data is hashed to produce a single hash string which is included in hash 30B.

Biometric validation process 300 may be performed for a third product transfer event involving product 14. For example, product handling site 12B (FIG. 1) may send product 14 to product handling site 12C. Computer 16C performs biometric validation process 300 for the third product transfer event. The received biometric ID is that of user 1C. For convenience, it may be referred to as a third biometric ID. In addition, the handler ID received in the biometric validation process for the third product transfer event may be referred to as a third handler ID. The validation step at S303 may be what was described for the second product transfer event. If computer 16C determines at S303 that the third biometric ID is not valid, computer 16C generates a fault signal at S304. The fault signal would indicate that the third biometric ID does not correspond to the third handler ID. If computer 16C determines that the third biometric ID is valid, computer 16B generates at S305 handling record 20C (third handling record). Third handling record 20C comprises the handling information and the biometric ID received in the biometric validation process for the third product transfer event. Next at S306, computer 16C forwards third handling record 20C to blockchain process 26. Computer 16C may perform blockchain process 26 at S307, or another node in network 22 may perform it. The blockchain process may be what was described for the second product transfer event.

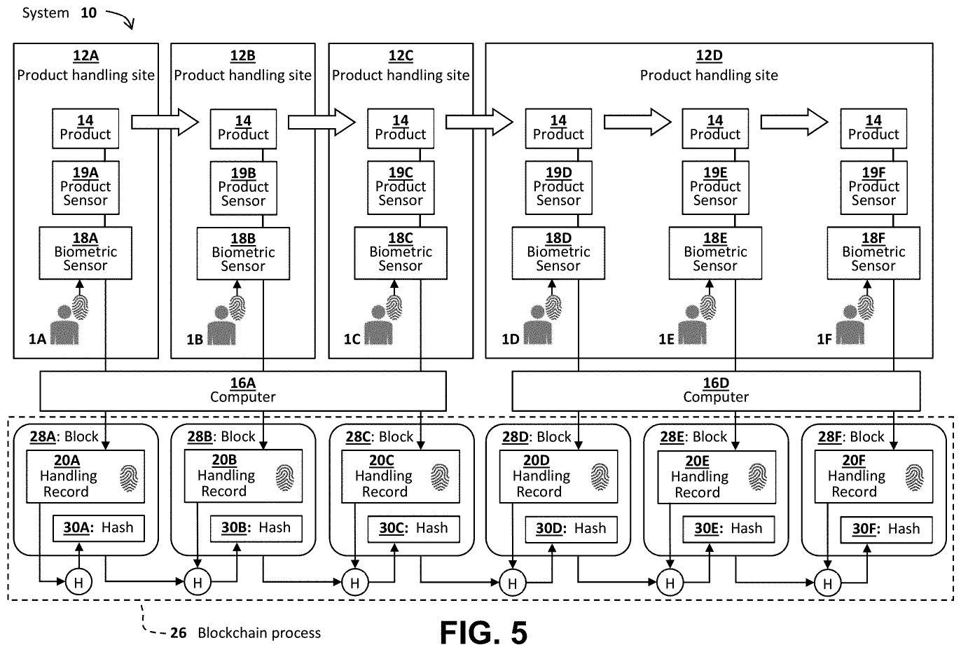

System 10 may be configured in other ways. As shown in FIG. 5, for example, multiple product handling sites may share computer 16. In such a case, the above processes described for handling the first product transfer event and second product transfer event may be performed by computer 16A. In addition, multiple product transfer events for the same product may occur at the same physical site 12D.

It is to be understood that the term “first handling site” need not be where a product originates. Similarly, it is to be understood that the term “first product transfer event” need not be the very first or starting event that occurs for a product. For example, the first, second, and third product transfer events may occur at product handling sites 12C, 12D, and 12E of FIG. 1.

While several particular forms of the invention have been illustrated and described, it will also be apparent that various modifications may be made without departing from the scope of the invention. It is also contemplated that various combinations or subcombinations of the specific features and aspects of the disclosed embodiments may be combined with or substituted for one another in order to form varying modes of the invention. Accordingly, it is not intended that the invention be limited, except as by the appended claims.

1. A method for applying biometric authentication in product distribution, the method comprising:
performing a biometric validation process, the biometric validation process performed for a first product transfer event involving a product, the biometric validation process comprising
receiving handling information comprising a product ID for the product and a handler ID, the handler ID linking the product with a societal entity or machine involved in handling the product,
receiving a biometric ID of a user associated with the handling information, and
determining whether the received biometric ID is valid, including determining whether the received biometric ID corresponds to the received handler ID; and
responsive to a determination that the received biometric ID is valid, forwarding a first handling record to a blockchain process, the first handling record comprising the received handling information, the blockchain process for establishing a first data block containing a first hash linked to the first handling record.

2. The method of claim 1, the method further comprising:
performing the biometric validation process for a second product transfer event involving the product.

3. The method of claim 2, wherein
the biometric ID received in the biometric validation process for the second product transfer event, is referred to as a second biometric ID,
the method further comprises,
responsive to a determination that the second biometric ID is valid, transmitting a second handling record to the blockchain process, the second handling record comprising the handling information received in the biometric validation process for the second product transfer event, and
the blockchain process is for establishing a second data block containing a second hash linked to the second handling record.

4. The method of claim 2, wherein
the biometric ID received in the biometric validation process for the second product transfer event, is referred to as a second biometric ID,
the handler ID received in the biometric validation process for the second product transfer event, is referred to as a second handler ID, and
the method further comprises:
responsive to a determination that the second biometric ID is not valid, transmitting a fault signal indicating that the second biometric ID does not correspond to the second handler ID.

5. The method of claim 2, wherein
in the biometric validation process for the first product transfer event, the received handling information comprises a next recipient ID identifying a societal entity that should receive the product in the second product transfer event.

6. The method of claim 5, wherein
in the biometric validation process for the second product transfer event, the determining of whether the received biometric ID is valid, comprises determining whether the received biometric ID corresponds to the next recipient ID received in the biometric validation process for the first product transfer event.

7. The method of claim 2, further comprising:
performing the biometric validation process for a third product transfer event involving the product, wherein the biometric ID received in the biometric validation process for the third product transfer event, is referred to as a third biometric ID,
responsive to a determination that the third biometric ID is valid, transmitting a third handling record to the blockchain process, the third handling record comprising the handling information received in the biometric validation process for the third product transfer event, and
the blockchain process is for establishing a third data block containing a third hash linked to the third handling record.

8. The method of claim 1, wherein
the received handler ID identifies a societal entity asserting control over the product.

9. The method of claim 1, wherein
the received handler ID comprises a personal ID of an individual person, and
the determining of whether the received biometric ID corresponds to the received handler ID comprises determining of whether the received biometric ID is associated with the personal ID.

10. The method of claim 1, wherein
the received handler ID comprises a group ID for a plurality of people, and
the determining of whether the received biometric ID corresponds to the received handler ID comprises determining of whether the received biometric ID is associated with group ID.

11. The method of claim 1, wherein
the received handler ID identifies a machine having a physical association with the product.

12. The method of claim 1, wherein
the product ID is based on or comprises output from a product sensor,
the handler ID comprises a device ID for the product sensor, and
the determining of whether the received biometric ID corresponds to the received handler ID comprises determining of whether the received biometric ID is associated with the device ID.

13. The method of claim 12, wherein the product sensor is configured to read information about the product using electromagnetic radiation directed toward the product.

14. A system for applying biometric authentication in product distribution, the system comprising a computer processor configured to perform a method comprising:
performing a biometric validation process, the biometric validation process performed for a first product transfer event involving a product, the biometric validation process comprising
receiving handling information comprising a product ID for the product and a handler ID, the handler ID linking the product with a societal entity or machine involved in handling the product,
receiving a biometric ID of a user associated with the handling information, and
determining whether the received biometric ID is valid, including determining whether the received biometric ID corresponds to the received handler ID; and
responsive to a determination that the received biometric ID is valid, forwarding a first handling record to a blockchain process, the first handling record comprising the received handling information, the blockchain process for establishing a first data block containing a first hash linked to the first handling record.

15. The system of claim 14, wherein the method, which the computer processor is configured to perform, further comprises:
performing the biometric validation process for a second product transfer event involving the product.

16. The system of claim 15, wherein
the biometric ID received in the biometric validation process for the second product transfer event, is referred to as a second biometric ID,
the method, which the computer processor is configured to perform, further comprises,
responsive to a determination that the second biometric ID is valid, transmitting a second handling record to the blockchain process, the second handling record comprising the handling information received in the biometric validation process for the second product transfer event, and
the blockchain process is for establishing a second data block containing a second hash linked to the second handling record.

17. The system of claim 15, wherein
the biometric ID received in the biometric validation process for the second product transfer event, is referred to as a second biometric ID,
the handler ID received in the biometric validation process for the second product transfer event, is referred to as a second handler ID, and
the method, which the computer processor is configured to perform, further comprises:
responsive to a determination that the second biometric ID is not valid, transmitting a fault signal indicating that the second biometric ID does not correspond to the second handler ID.

18. The system of claim 15, wherein
in the biometric validation process for the first product transfer event, the received handling information comprises a next recipient ID identifying a societal entity that should receive the product in the second product transfer event.

19. The system of claim 18, wherein
in the biometric validation process for the second product transfer event, the determining of whether the received biometric ID is valid, comprises determining whether the received biometric ID corresponds to the next recipient ID received in the biometric validation process for the first product transfer event.

20. A non-transitory computer-readable medium storing instructions, which when executed by a computer processor, cause the computer processor to perform a method for applying biometric security, the method comprising:
performing a biometric validation process, the biometric validation process performed for a first product transfer event involving a product, the biometric validation process comprising
receiving handling information comprising a product ID for the product and a handler ID, the handler ID linking the product with a societal entity or machine involved in handling the product,
receiving a biometric ID of a user associated with the handling information, and
determining whether the received biometric ID is valid, including determining whether the received biometric ID corresponds to the received handler ID; and
responsive to a determination that the received biometric ID is valid, forwarding a first handling record to a blockchain process, the first handling record comprising the received handling information, the blockchain process for establishing a first data block containing a first hash linked to the first handling record.
